(19) United States
(12) Patent Application Publication
(10) Pub. No.: US 2016/0322726 A1
(43) Pub. Date: Nov. 3, 2016

(54) TERMINAL CONNECTING STRUCTURE AND SEMICONDUCTOR DEVICE

(71) Applicants: TOYOTA JIDOSHA KABUSHIKI KAISHA, Toyota-shi (JP); DENSO CORPORATION, Kariya-shi (JP)

(72) Inventors: Takuya KADOGUCHI, Toyota-shi (JP); Takahiro HIRANO, Toyota-shi (JP); Arata HARADA, Gamagoori-shi (JP); Tomomi OKUMURA, Anjo-shi (JP); Keita FUKUTANI, Anjo-shi (JP); Masayoshi NISHIHATA, Nagoya-shi (JP)

(73) Assignees: TOYOTA JIDOSHA KABUSHIKI KAISHA, Toyota-shi (JP); DENSO CORPORATION, Kariya-shi (JP)

(21) Appl. No.: 15/110,224

(22) PCT Filed: Dec. 30, 2014
(86) PCT No.: PCT/IB2014/002898

§ 371 Date: Jul. 7, 2016

(30) Foreign Application Priority Data
Jan. 7, 2014 (JP) 2014-001184

(51) Int. Cl. H01R 13/03; H01R 13/05; H01R 13/11; H01R 12/71

(52) U.S. Cl. CPC H01R 13/03; H01R 12/716; H01R 13/05; H01R 13/11; H01R 2201/26

(57) ABSTRACT

A terminal connecting structure includes: a male terminal; and a female terminal to which the male terminal is fitted. The male terminal includes a first metal material and a first metal film that is formed on an outermost surface of the male terminal to coat the first metal material directly or indirectly. The female terminal includes a second metal material and a second metal film that is formed on an outermost surface of the female terminal to coat the second metal material directly or indirectly. A hardness of the first metal material is different from a hardness of the second metal material.

### BACKGROUND OF THE INVENTION

1. Field of the Invention

The present invention relates to a terminal connecting structure and a semiconductor device including the terminal connecting structure.

2. Description of Related Art

A structure is known in which an external connection terminal (male side) of an electronic component is inserted into a through-hole (female side) of a substrate and is connected to wiring of the substrate by soldering or the like. Examples of this structure include a semiconductor device in which an external connection terminal of a semiconductor module with a resin-sealed semiconductor element is inserted into a through-hole of a substrate and is connected to wiring of the substrate by soldering or the like (for example, refer to Japanese Patent Application Publication No. 2010-199622 (JP 2010-199622 A)).

However, in the above-described technique, since a process of connecting a terminal to wiring by soldering or the like is necessary, a manufacturing process is complex. Accordingly, it is preferable to use a terminal connecting structure in which a male-side terminal is connected to a female-side terminal instead of connecting a terminal to wiring by soldering or the like.

However, such a terminal connecting structure may be mounted on an electronic apparatus which is used in an environment of being easily affected by a vibration, for example, an on-vehicle environment. Therefore, a structure is necessary which is made while sufficiently taking the durability of a terminal, for example, an initial wear amount, a sliding wear amount, or deformation of the terminal into consideration.

### SUMMARY OF THE INVENTION

The invention provides a terminal connecting structure and a semiconductor device including the terminal connecting structure, in which the durability of a terminal can be secured.

According to a first aspect of the invention, there is provided a terminal connecting structure including: a male terminal; and a female terminal to which the male terminal is fitted. The male terminal includes a first metal material and a first metal film that is formed on an outermost surface of the male terminal to coat the first metal material directly or indirectly. The female terminal includes a second metal material and a second metal film that is formed on an outermost surface of the female terminal to coat the second metal material directly or indirectly. A hardness of the first metal material is different from a hardness of the second metal material.

According to a second aspect of the invention, there is provided a semiconductor device including: the terminal connecting structure according to the first aspect of the invention; and a substrate on which a connector is mounted. The male terminal is an external connection terminal of a semiconductor module. The female terminal is equipped in the connector.

According to the first and second aspects of the invention, a terminal connecting structure and a semiconductor device in which the durability of a terminal can be secured can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIGS. 1A and 1B are diagrams illustrating a semiconductor device according to a first embodiment of the invention;

FIG. 2 is a perspective view illustrating a semiconductor module according to the first embodiment;

FIG. 3 is a schematic cross-sectional view illustrating a structure of a portion where a male terminal is fitted to a female terminal;

FIG. 4 is a schematic cross-sectional view illustrating reduction in wear;

FIG. 5 is a diagram illustrating an SN curve indicating the hardness of a copper material; and

FIG. 6 is a diagram illustrating a relationship between a Vickers hardness and a deformation amount of a surface treatment material.

### DETAILED DESCRIPTION OF EMBODIMENTS

Hereinafter, embodiments of the invention will be described with reference to the drawings. In each embodiment, a semiconductor device in which a male terminal which is an external connection terminal of a semiconductor module is fitted to a female terminal which is equipped in a connector mounted on a substrate will be described as an example of a terminal connecting structure. However, the terminal connecting structure according to the invention is not limited to these embodiments. For example, a male terminal which is an external connection terminal of an electronic component (for example, a capacitor) not equipped with a semiconductor element may be fitted to a female terminal which is equipped in a connector mounted on a substrate. Alternatively, a male terminal which protrudes from a first connector mounted on a first substrate may be fitted to a female terminal which is equipped in a second connector mounted on a second substrate. In each drawing, the same components are represented by the same reference numerals, and the description thereof will not be repeated.

### First Embodiment

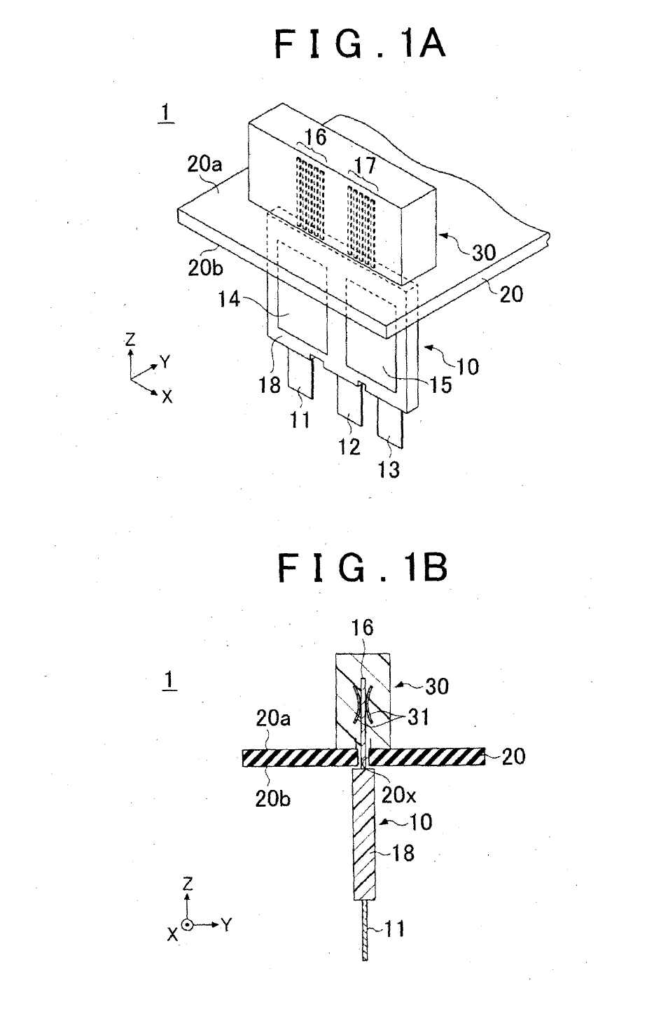

FIGS. 1A and 1B are diagrams illustrating a semiconductor device according to a first embodiment of the invention, in which FIG. 1A is a perspective view, and FIG. 1B is a cross-sectional view taken along a plane which is parallel to a YZ plane of FIG. 1A and passes through a male terminal 16 (described below). As illustrated in FIGS. 1A and 1B, a semiconductor device 1 includes a semiconductor module 10, a substrate 20, and a connector 30. In the semiconductor device 1, male terminals 16, 17 which are external connection terminals of the semiconductor module 10 are fitted to female terminals 31, which are equipped in the connector 30, through the substrate 20.

Hereinafter, the semiconductor device 1 will be described. First, the semiconductor module 10, the substrate 20, and the connector 30 will be briefly described, and then a structure (terminal connecting structure) of a portion where the male terminals 16, 17 of the semiconductor module 10 are fitted to the female terminals 31 of the connector 30 will be described in detail.

First, the semiconductor module 10 will be described. An internal structure of the semiconductor module 10 is not particularly limited as long as it includes a male terminal which is an external connection terminal. However, in the embodiment, a semiconductor module including an IGBT (insulated gate bipolar transistor) and a diode will be described below as an example.

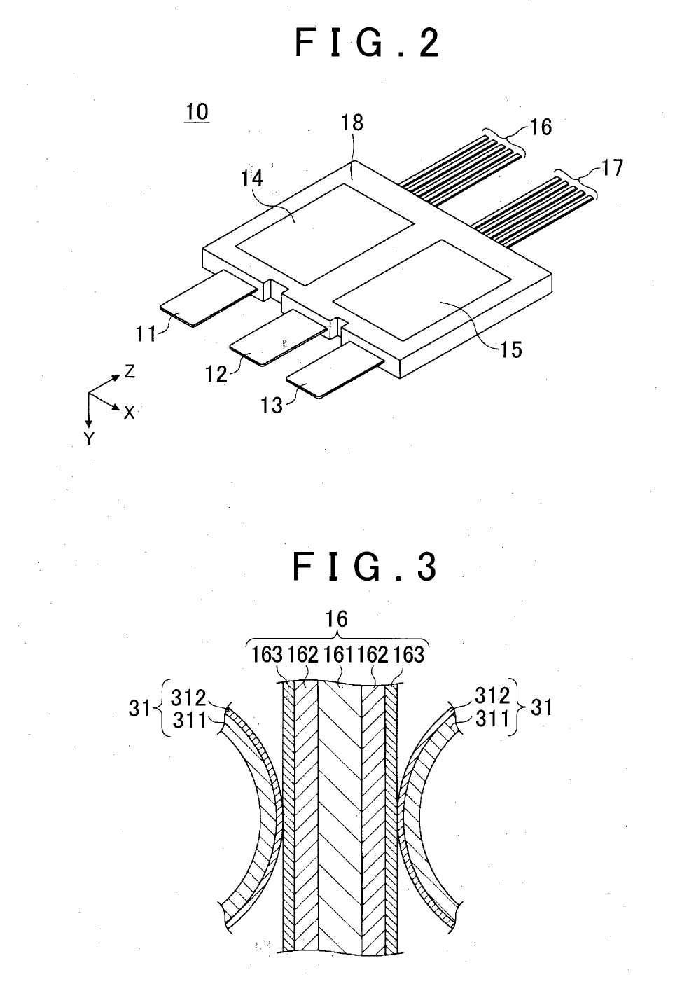

FIG. 2 is a perspective view illustrating the semiconductor module according to the first embodiment. Referring to FIGS. 1A to 2, the semiconductor module 10 includes a metal plate 11, a metal plate 12, a metal plate 13, a metal plate 14, a metal plate 15, plural male terminals 16, plural male terminals 17, and a sealing resin 18.

In the semiconductor module 10, a first semiconductor element (not illustrated) is mounted so as to be interposed between the metal plates 11 and 14. In addition, a second semiconductor element (not illustrated) is mounted so as to be interposed between the metal plates 13 and 15.

The metal plates 11, 12, 13 are electrically connected to electrodes of either or both of the first and second semiconductor elements and can be used as a part of input and output terminals of the first and second semiconductor elements. In addition, the metal plates 11 to 15 can dissipate heat generated during the operation of the first semiconductor element or the second semiconductor element to the outside.

As a material of the metal plates 11 to 15, for example, copper (Cu) or aluminum (Al) may be used. A plating may be formed on surfaces of the metal plates 11 to 15. The metal plates 11 to 15 can be manufactured from, for example, a lead frame.

The first semiconductor element is, for example, an IGBT that constitutes a part of an inverter circuit or a buck-boost converter circuit mounted on a vehicle, and a free wheeling diode that is connected between an emitter and a collector of an IGBT. The second semiconductor element is the same as that in the case of the first semiconductor element.

The male terminals 16 are metal terminals which are external connection terminals of the semiconductor module 10 and are electrically connected to the first semiconductor element, a temperature sensor, and the like through, for example, a bonding wire. The male terminals 17 are metal terminals which are external connection terminals of the semiconductor module 10 and are electrically connected to the second semiconductor element, a temperature sensor, and the like through, for example, a bonding wire.

The metal plates 11 to 15, the male terminals 16, 17, and the first and second semiconductor elements are sealed with the sealing resin 18. However, end portions of the metal plates 11 to 13 protrude from the sealing resin 18 to the outside. In addition, predetermined surfaces of the metal plates 14, 15 are exposed from the sealing resin 18 to the outside. Further, end portions of the male terminals 16, 17 protrude from the sealing resin 18 to the outside. The end portions of the metal plates 11 to 13 and the end portions of the male terminals 16, 17 protrude in a direction opposite a Z direction. As a material of the sealing resin 18, for example, an epoxy-based resin containing a filler may be used.

Referring to FIG. 1, the substrate 20 is a portion on which the semiconductor module 10 is mounted. On the substrate 20, a circuit (not illustrated) for driving the semiconductor module 10 can be provided. As the substrate 20, for example, a so-called glass epoxy substrate which is a glass cloth impregnated with an insulating resin such as an epoxy-based resin, a silicon substrate, or a ceramic substrate may be used. Multiple wiring layers may be provided on the substrate 20.

Plural penetrating portions 20x into which the male terminals 16, 17 of the semiconductor module 10 are inserted are formed on the substrate 20. A planar shape of each of the penetrating portions 20x may be, for example, a rectangular shape or a circular shape conforming to a cross-sectional shape of the male terminals 16, 17 in a direction perpendicular to a longitudinal direction thereof. The planar shape described herein refers to a shape of the observation target when seen from a normal direction of one surface 20a of the substrate 20.

In order to make the male terminals 16, 17 insertable into the penetrating portions 20x, the planar shape of each of the penetrating portions 20x is formed to be larger than the cross-sectional shape of the male terminals 16, 17 in the direction perpendicular to the longitudinal direction. Accordingly, there are gaps between an inner wall surface of each of the penetrating portions 20x and side portions of each of the male terminals 16, 17. For example, the penetrating portions 20x may be holes or notches penetrating the substrate 20.

The connector 30 is mounted on the surface 20a side of the substrate 20. The connector 30 includes female terminals 31 which individually correspond to the number of the male terminals 16, 17. Each of the female terminals 31 can be electrically connected to the circuits formed on the substrate 20.

The male terminals 16, 17 of the semiconductor module 10 are inserted from a surface 20b side of the substrate 20 opposite the surface 20a into the female terminals 31 of the connector 30 through the penetrating portions 20x such that the male terminals 16, 17 are fitted to the female terminals 31. As a result, the first and second semiconductor elements of the semiconductor module 10 are electrically connected to wiring (circuit) formed on the substrate 20 through the male terminals 16, 17 and the female terminals 31 of the connector 30.

In the semiconductor device 1, the single semiconductor module 10 is fitted to the connector 30 through the substrate 20. However, plural semiconductor modules 10 may be fitted to connectors 30 which individually correspond to the semiconductor modules 10 through the substrate 20.

Next, the structure (terminal connecting structure) of a portion where the male terminals 16, 17 of the semiconductor module 10 are fitted to the female terminals 31 of the connector 30 will be described in detail. FIG. 3 is a schematic cross-sectional view illustrating a structure of a portion where a male terminal is fitted to a female terminal and is also an enlarged view illustrating a part of a cross-section corresponding to FIG. 1B.

Referring to FIG. 3, the male terminal 16 includes a metal material 161 that is a base material formed on the center side, a metal film 162 that is formed to coat the metal material 161, and a metal film 163 that is a surface treatment material formed on the outermost surface of the male terminal 16 to coat the metal film 162. The base material described herein refers to a portion which forms a base for forming the surface treatment material and the like. The metal material 161 may be considered a representative example of the first metal material according to the invention. In addition, the metal film 163 may be considered a representative example of the first metal film according to the invention.

The metal film 162 is not an essential component of the male terminal 16, and the metal film 163 may be directly formed to coat the metal material 161. That is, the metal film 163 may be formed on the outermost surface of the male terminal 16 to coat the metal material 161 directly or indirectly. Although the male terminal 17 is not illustrated, the male terminal 17 has the same structure as the male terminal 16.

As the metal material 161, for example, a metal plate containing copper (Cu), a copper alloy, aluminum (Al), or an aluminum alloy as a major component may be used. The thickness of the metal material 161 may be, for example, about 0.2 mm to 0.8 mm. The major component described herein refers to a material having the highest contents (in wt %) in a member when plural metals or additives or the like are contained in the member. In this case, metals or additives or the like other than the major component will be referred to as minor components.

As the metal film 162, for example, a metal film containing nickel (Ni) as a major component may be used. The thickness of the metal film 162 may be, for example, about 2 μm to 15 μm. The metal film 162 can be formed on the metal material 161, for example, by plating. In addition, the metal film 162 may have a structure in which plural metal films are laminated. For example, the metal film 162 may have a structure in which a nickel (Ni) film on the metal material 161 side and a palladium (Pd) film on the metal film 163 side are laminated.

As the metal film 163, for example, a metal film containing a noble metal such as gold (Au), platinum (Pt), palladium (Pd), or rhodium (Rh) as a major component may be used. The thickness of the metal film 163 may be, for example, about 0.3 μm to 0.8 μM. The metal film 163 can be formed on the metal film 162, for example, by plating.

The female terminal 31 includes a metal material 311 that is a base material, and a metal film 312 that is a surface treatment material formed on the outermost surface of the female terminal 31 to coat the metal material 311. The metal material 311 may be considered a representative example of the second metal material according to the invention. In addition, the metal film 312 may be considered a representative example of the second metal film according to the invention.

The female terminal 31 has a spring property. The female terminal 31 includes portions that are respectively arranged on opposite sides of the male terminal 16 and that have the same structure. The female terminal 31, using its spring property, presses down the opposite sides of the male terminal 16 with the opposite portions of the female terminal 31 so as to hold the male terminal 16 at two points. The metal film 312 of the female terminal 31 is in contact with the metal film 163 of the male terminal 16. The female terminal 31 may be constituted by a plurality of female terminals that are respectively arranged on the opposite sides of the male terminal 16.

The opposite portions of the female terminal 31 are arranged opposite each other at an interval, at which the male terminal 16 is insertable into the female terminal 31 before the insertion and is pressed down by the opposite portions of the female terminal 31 from the opposite sides due to the spring property after the insertion, such that portions of the metal film 312 face inward (toward the side in contact with the male terminal 16). The portions of the female terminal 31 on the opposite sides of the male terminal 16 are integrated in the connector 30 and are electrically connected (not illustrated).

As the metal material 311, for example, a metal plate containing copper (Cu), a copper alloy, aluminum (Al), or an aluminum alloy as a major component may be used. The thickness of the metal material 311 may be, for example, about 0.1 mm to 0.3 mm.

As the metal film 312, for example, a metal film containing a noble metal such as gold (Au), platinum (Pt), palladium (Pd), or rhodium (Rh) may be used. The thickness of the metal film 312 may be, for example, about 0.3 μm to 0.8 μm. The metal film 312 can be formed on the metal material 311, for example, by plating. The hardness of the metal film 312 may be, for example, the same as the hardness of the metal film 163.

The female terminal 31 may have a metal film held between the metal material 311 and the metal film 312. The material and the thickness of the metal film held between the metal material 311 and the metal film 312 are, for example, the same as those of the metal film 162 of the male terminal 16.

In the embodiment, the hardness (Vickers hardness) of the metal material 161 which is the base material of the male terminal 16 and the hardness of the metal material 311 which is the base material of the female terminal 31 are made different from each other. Specifically, the hardness of the metal material 311 of the female terminal 31 is made higher than the hardness of the metal material 161 of the male terminal 16. That is, the metal material 311 of the female terminal 31 is made harder than the metal material 161 of the male terminal 16.

In this way, by making the metal material 311 of the female terminal 31 harder than the metal material 161 of the male terminal 16, even when the semiconductor device 1 is used in an environment of being easily affected by a vibration, the wear amount of contact points between the male terminal 16 and the female terminals 31 (the portions where the metal film 163 and the metal film 312 are in contact with each other) can be reduced. Examples of the environment of being easily affected by a vibration include a case where the semiconductor device 1 is mounted on a moving body. Examples of the moving body include an automobile, a motorcycle, and a train.

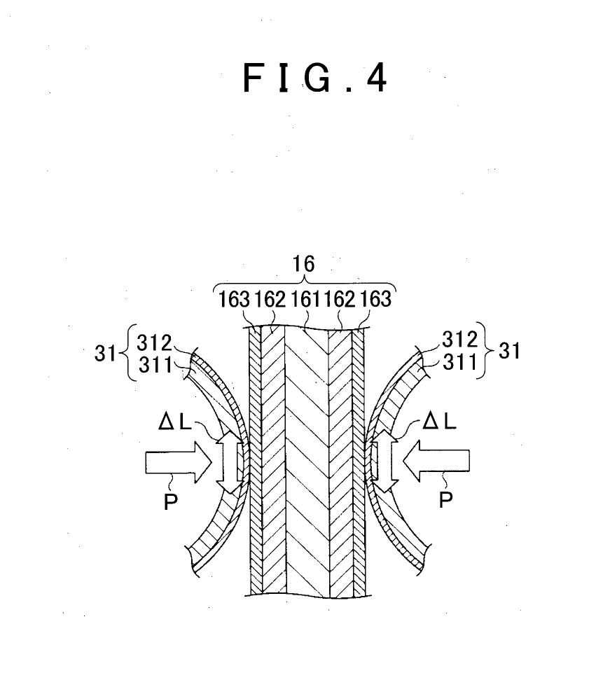

Hereinafter, the wear reduction effect will be described in more detail with reference to FIG. 4. FIG. 4 schematically illustrates a state where the semiconductor device 1 is used in an environment of being easily affected by a vibration in which the male terminal is fitted to the female terminal. In FIG. 4, the male terminal 16 is pressed down with a contact pressure P by the female terminal 31 so as to be held at two points from the opposite sides. In addition, the male terminal 16 and the female terminal 31 are vibrated and are relatively slid in a sliding distance ΔL.

At this time, when the wear amount is represented by W, a friction coefficient is represented by k, and the Vickers hardness is represented by Hv, a relationship of Expression 1 is established. The friction coefficient k is determined depending on the surface roughnesses, the contact areas, and the like of the metal film 163 of the male terminal 16 and the metal film 312 of the female terminal 31.

$$W ∝ k \frac{P}{Hv} \times Δ L \qquad [ Expression 1 ]$$

It can be seen from Expression 1 that, when the contact pressure P is reduced, the wear amount W can be reduced. In addition, it can be seen that, when the sliding distance ΔL is reduced, the wear amount W can be reduced. In addition, it can be seen that, when the Vickers hardness Hv is increased, the wear amount W can be reduced.

In the embodiment, the metal material 311 of the female terminal 31 that presses the male terminal 16 at two points from the opposite sides is harder than the metal material 161 of the male terminal 16. In this structure, the followability of the metal material 311 to the metal material 161 is high, and thus a spring load of the metal material 311 is likely to be transferred to the metal material 161. In addition, since the metal material 311 strongly presses the metal material 161 down, the initial deformation amounts of the metal film 163 of the male terminal 16 and the metal film 312 of the female terminal 31 increase. However, since the metal film 163 and the metal film 312 mesh with each other, the sliding distance ΔL can be reduced. As a result of the distance ΔL being reduced, as can be seen from Expression 1, the wear amount W (sliding wear amount) of the metal film 163 of the male terminal 16 and the metal film 312 of the female terminal 31 can be reduced (vibration durability can be secured).

In order to make the hardness of the metal material 311 of the female terminal 31 higher than the hardness of the metal material 161 of the male terminal 16, for example, it is necessary that materials, which contain the same metal material as major components and contain predetermined minor components, respectively, be selected as the metal material 311 and the metal material 161, and the contents of the respective minor components in the metal material 311 and the metal material 161 be adjusted (the contents of the respective minor components may be zero).

For example, in order to form the metal material 311 and the metal material 161, materials shown in Table 1, which contain copper as major components and contain other metals as minor components (do not contain minor components), respectively, may be appropriately combined.

TABLE 1

| | Oxygen-Free | | |
|---|---|---|---|
| | Copper | Cu—Sn Alloy | Cu—Zr Alloy |
| Hardness (Hv) | 115 | 120 | 120 |
| Softening | 200 | 350 | 450 |
| Temperature (° C.) | | | |
| | | Cu—Ni—Si | Cu—Cr—Sn—Zn |
| | Cu—Fe Alloy | Alloy | Alloy |
| Hardness (Hv) | 135 | 180 | 175 |
| Softening | 460 | 500 | 500 |
| Temperature (° C.) | | | |

Alternatively, for example, the same material shown in Table 1 may be used as the metal material 311 and the metal material 161, and a member which is to form the metal material 161 may be softened by being heated at a temperature higher than the softening temperature shown in Table 1 and then cooled. The hardnesses and the softening temperatures shown in Table 1 are representative values and are not limited to these values.

In another example, beryllium copper containing copper as a major component and containing beryllium as a minor component is used as the metal material 311 and the metal material 161. By making the beryllium content in the metal material 311 higher than the beryllium content in the metal material 161, the hardness of the metal material 311 can be made higher than the hardness of the metal material 161.

Alternatively, a Corson copper alloy containing copper as a major component and containing nickel (Ni), silicon (Si), magnesium (Mg), or the like as a minor component may be used as the metal material 311 and the metal material 161. Then, by adjusting the content of nickel (Ni), silicon (Si), magnesium (Mg), or the like which is the minor component of the Corson copper alloy, the hardness of the metal material 311 may be made higher than the hardness of the metal material 161.

Alternatively, by using materials, which contain different metal materials as major components, respectively, as the metal material 311 and the metal material 161, the hardness of the metal material 311 may be made higher than the hardness of the metal material 161. For example, a material which contains copper or a copper alloy as a major component may be used as the metal material 311, and a material which contains aluminum or an aluminum alloy having a lower hardness than copper or a copper alloy as a major component may be used as the metal material 161.

Alternatively, by using materials, which contain the same metal material as major components, respectively, as the metal material 311 and the metal material 161, the metal material 311 may be heated (quenched) so as to be harder than the metal material 161.

### Modification Example of First Embodiment

In a modification example of the first embodiment, as in the case of the first embodiment, the hardness (Vickers hardness) of the metal material 161 which is the base material of the male terminal 16 and the hardness of the metal material 311 which is the base material of the female terminal 31 are made different from each other. However, in the modification example of the first embodiment, unlike the first embodiment, the hardness of the metal material 161 of the male terminal 16 is made higher than the hardness of the metal material 311 of the female terminal 31. That is, the metal material 161 of the male terminal 16 is made harder than the metal material 311 of the female terminal 31.

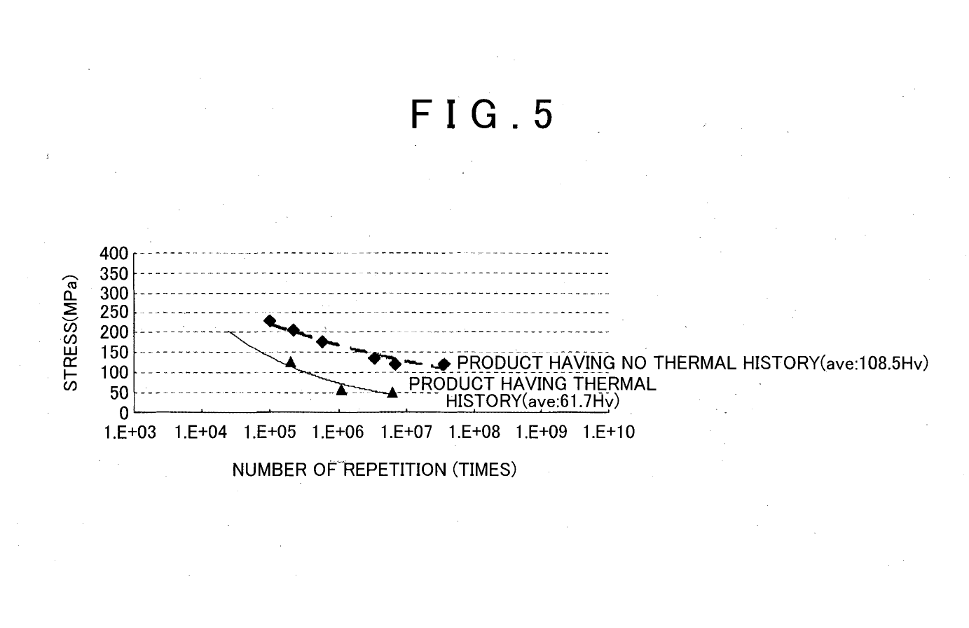

FIG. 5 is a diagram illustrating an SN curve indicating the hardness of a copper material. In FIG. 5, data (diamond) of samples having no thermal history and a high Vickers hardness and data (triangle) of samples having a thermal history and a low Vickers hardness are illustrated. In each of the diamond data and the triangle data, an approximation curve is plotted in the center of a distribution of plural pieces of data. The average value of the Vickers hardnesses of the samples having no thermal history is 108.5 Hv, and the average value of the Vickers hardnesses of the samples having a thermal history is 61.7 Hv. The vertical axis represents a repeated stress value (MPa) applied to a material at a fixed amplitude, and the horizontal axis represents the number of repetition (times).

As illustrated in FIG. 5, the samples having a high Vickers hardness have a higher fatigue limit and can endure a higher stress (do not break) as compared to the samples having a low Vickers hardness. In FIG. 5, the SN curve of the copper material is plotted as an example. However, in the case of other materials, the fatigue limit is high at a high Vickers hardness. Even when a difference in Vickers hardness is made using a method other than the method using the presence or absence of a thermal history, the fatigue limit is high at a high Vickers hardness.

In this way, a member having a high Vickers hardness has a higher fatigue limit than a member having a low Vickers hardness.

When the semiconductor device 1 is used in an environment of being easily affected by a vibration, the male terminal 16 having no spring property is likely to be displaced by a vibration. Therefore, the metal material 161 which is the base material of the male terminal 16 may be displaced and broken. Accordingly, in the embodiment, the hardness of the metal material 161 which is the base material of the male terminal 16 is made higher than the hardness of the metal material 311 which is the base material of the female terminal 31. Therefore, the metal material 161 has a higher fatigue limit than the metal material 311, the risk of being deformed or broken is reduced, and the durability (terminal strength) of the male terminal 16 can be secured.

As can be understood from the description of the first embodiment and the modification example thereof, it is technically important to make a difference in hardness between the metal material 161 which is the base material of the male terminal 16 and the metal material 311 which is the base material of the female terminal 31. That is, the specific effects described in the first embodiment and the modification example thereof are exhibited by making, among the metal material 161 which is the base material of the male terminal 16 and the metal material 311 which is the base material of the female terminal 31, one metal material harder and the other metal material softer. Accordingly, one of the metal materials may be selected and be made harder according to the required specification.

In both the first embodiment and the modification example thereof, since a process of connecting the male terminal 16 to wiring of the substrate 20 by soldering, welding or the like is unnecessary, a manufacturing complex can be simplified. In addition, the durability of at least one of the male terminal 16 and the female terminal 31 can be improved as compared to a case where the base material of the male terminal 16 and the base material of the female terminal 31 have the same hardness. The above description relates to the male terminal 16 and the female terminal 31. However, since the male terminal 17 has the same structure as the male terminal 16, the same effects are exhibited as in the case of the male terminal 17 and the female terminal 31.

### Second Embodiment

In a second embodiment, the hardness (Vickers hardness) of the metal film 163 which is the surface treatment material of the male terminal 16 and the hardness of the metal film 312 which is the surface treatment material of the female terminal 31 are made different from each other. Specifically, the hardness of the metal film 312 of the female terminal 31 is made higher than the hardness of the metal film 163 of the male terminal 16. That is, the metal film 312 of the female terminal 31 is made harder than the metal film 163 of the male terminal 16.

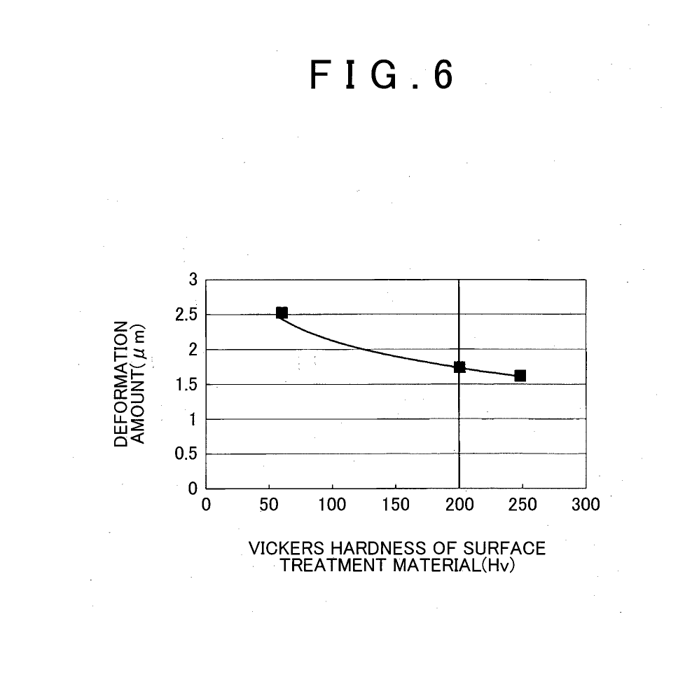

FIG. 6 is a diagram illustrating a relationship between the Vickers hardness and a deformation amount of the metal film 312 of the female terminal 31. In this case, the Vickers hardness of the metal film 163 of the male terminal 16 is fixed to 100 Hv. In FIG. 6, gold films having the same thickness are used as the metal film 163 and the metal film 312. In FIG. 6, the contact pressure P is set to be 4 N.

In FIG. 6, the deformation amount of the metal film 312 is about 1.5 μm to 2.5 μm which is greater than the thickness (about 0.3 μm to 0.8 μm) of the metal film 312. This is because the metal material 311 which is thicker than the metal film 312 is present below the metal film 312, and the metal film 312 is deformed along with the deformation (depression) of the metal material 311. The thickness of the metal film 312 does not substantially change.

As illustrated in FIG. 6, as a difference in Vickers hardness between the metal film 312 of the female terminal 31 and the metal film 163 of the male terminal 16 increases, the deformation amount of the metal film 312 decreases. When the Vickers hardness of the metal film 312 of the female terminal 31 is higher than 200 Hv, that is, when a difference in Vickers hardness between the metal film 312 of the female terminal 31 and the metal film 163 of the male terminal 16 is 100 Hv or higher, the deformation amount of the metal film 312 gradually approaches a fixed value.

In this way, by making a difference in Vickers hardness between the metal film 312 of the female terminal 31 and the metal film 163 of the male terminal 16 100 Hv or higher, the deformation amount of the metal film 312 can be reduced. It is known that, when the deformation amount decreases, the initial wear amount also decreases. Here, the deformation refers to the depression of the metal film 163 and the metal film 312 caused immediately after the male terminal 16 is fitted to the female terminal 31. The wear refers to a decrease in the thicknesses of the metal film 163 and the metal film 312 caused by a vibration after the deformation.

When the semiconductor device 1 is used in an environment of being easily affected by a vibration, the male terminal 16 is slid by a vibration, and thus a region of the metal film 163 which comes into contact with the metal film 312 varies. On the other hand, in the female terminal 31, a region of the metal film 312 which comes into contact with the metal film 163 is continuously the same.

Accordingly, in the embodiment, the hardness of the metal film 312 of the female terminal 31 is made higher than the hardness of the metal film 163 of the male terminal 16. As a result, the wear and the deformation of the metal film 312 can be suppressed as compared to a case where the metal film 312 of the female terminal 31 and the metal film 163 of the male terminal 16 have the same hardness. That is, the durability of the female terminal 31 can be secured.

In order to make the hardness of the metal film 312 of the female terminal 31 higher than the hardness of the metal film 163 of the male terminal 16, for example, it is necessary that materials, which contain the same metal material as major components and contain predetermined minor components, respectively, be selected as materials of the metal film 163 and the metal film 312, and the contents of the respective minor components in the metal film 163 and the metal film 312 be adjusted. For example, a metal film containing gold (Au) as a major component and containing cobalt (Co) as a minor component may be used as the materials of the metal film 163 and the metal film 312. By making the cobalt content in the metal film 312 to be higher than the cobalt content in the metal film 163, the hardness of the metal film 312 can be made higher than the hardness of the metal film 163. In this case, the metal film 163 may not contain cobalt (for example, pure gold may be used).

Alternatively, by using materials, which contain different metal materials as major components, respectively, as the materials of the metal film 163 and the metal film 312, the hardness of the metal film 312 may be made higher than the hardness of the metal film 163. For example, a material which contains platinum (Pt) as a major component may be used as the material of the metal film 312, and a material which contains gold (Au) having a lower hardness than platinum (Pt) as a major component may be used as the material of the metal film 163.

In the second embodiment, since a process of connecting the male terminal 16 to wiring of the substrate 20 by soldering, welding or the like is unnecessary, a manufacturing complex can be simplified. In addition, the wear and the deformation of the female terminal 31 can be suppressed and the durability can be improved, as compared to a case where the surface treatment material of the male terminal 16 and the surface treatment material of the female terminal 31 have the same hardness. The above description relates to the male terminal 16 and the female terminal 31. However, since the male terminal 17 has the same structure as the male terminal 16, the same effects are exhibited as in the case of the male terminal 17 and the female terminal 31.

Hereinabove, the preferred embodiments and the modification examples thereof have been described. However, the invention is not limited to the above-described embodiments and the modification examples thereof. Embodiments obtained by applying various modifications and substitutions to the above-described embodiments and the modification examples thereof may be adopted.

For example, the first embodiment or the modification example thereof may be combined with the second embodiment. As a result, the respective effects described in the first embodiment or the modification example thereof and the second embodiment can be obtained at the same time.

In the above-described embodiments and the modification examples thereof, the Vickers hardness is set as an index indicating a difference in the hardness of the object. However, another means other than the Vickers hardness may be set as an index indicating a difference in the hardness of the object.

The terminal connecting structure according to the invention exhibits the predetermined effects when being used in an environment of being easily affected by a vibration. On the other hand, the terminal connecting structure according to the invention may also be used in an environment other than the environment of being easily affected by a vibration.

1. A terminal connecting structure comprising:
a male terminal; and
a female terminal to which the male terminal is fitted, wherein
the male terminal includes a first metal material and a first metal film that is formed on an outermost surface of the male terminal to coat the first metal material directly or indirectly,
the female terminal includes a second metal material and a second metal film that is formed on an outermost surface of the female terminal to coat the second metal material directly or indirectly, and
a hardness of the first metal material is different from a hardness of the second metal material.

2. The terminal connecting structure according to claim 1, wherein
the hardness of the second metal material is a higher than the hardness of the first metal material.

3. The terminal connecting structure according to claim 1, wherein
the hardness of the first metal material is a higher than the hardness of the second metal material.

4. The terminal connecting structure according to claim 1, wherein
a hardness of the second metal film is higher than a hardness of the first metal film.

5. The terminal connecting structure according to of claim 1, wherein
the female terminal has a spring property, and
the female terminal is configured to press down opposite sides of the male terminal so as to hold the male terminal at two points.

6. A semiconductor device comprising:
the terminal connecting structure according to claim 1, and
a substrate on which a connector is mounted, wherein
the male terminal is an external connection terminal of a semiconductor module, and
the female terminal is equipped in the connector.

7. The semiconductor device according to claim 6, wherein
a penetrating portion into which the male terminal is inserted is formed on the substrate,
the male terminal is inserted from a first surface side of the substrate into the penetrating portion,
the connector is mounted on a second surface of the substrate opposite the first surface, and
the male terminal is fitted to the female terminal through the penetrating portion.
